(19) United States
(12) Patent Application Publication
(10) Pub. No.: US 2010/0104855 A1
(43) Pub. Date: Apr. 29, 2010

(54) PREFORM MANUFACTURING METHOD, PREFORM MANUFACTURING APPARATUS, PREFORM AND OPTICAL MEMBER

(75) Inventors: Masato Yoshioka, Odawara-shi (JP); Noriko Eiha, Odawara-shi (JP); Seiichi Watanabe, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 12/528,930

(22) PCT Filed: Mar. 28, 2008
(86) PCT No.: PCT/JP2008/056720

§ 371 Date: Aug. 27, 2009

(30) Foreign Application Priority Data
Mar. 30, 2007 (JP) 2007-095373

(51) Int. Cl. B29D 11/00; B29C 33/42; B32B 5/22

(52) U.S. Cl. 428/323; 264/1.1; 264/1.7; 425/112

(57) ABSTRACT

A method for manufacturing a preform from a nano composite resin that includes a thermoplastic resin containing inorganic fine particles, the preform being a pre-finish product of an optical member having an optical surface formed by press molding, is provided. The method includes: supplying a solution including the nano composite resin and a solvent into a mold which has an approximate optical surface closely resembling the optical surface and an opening to an atmosphere; and evaporating the solvent while a shape of the approximate optical surface is kept, to solidify the solution.

### TECHNICAL FIELD

The present invention relates to a manufacturing method and apparatus of a preform for an optical member, a preform manufactured by the method, and an optical member formed from the preform, and more particularly, to a manufacturing method and apparatus of a preform from which an optical member that is excellent in optical characteristic can be formed, a preform manufactured by the method, and an optical member formed from the preform.

### BACKGROUND ART

With high performance, miniaturization, and cost reduction of recent optical information recording devices such as a portable camera, a DVD, a CD, and a MO drive, superior material and development of a process are greatly desired for an optical member such as an optical lens or a filter used in these optical information recording devices.

Particularly, a plastic lens is more lightweight and more difficult to crack than an inorganic material such as glass, and can be processed in various shapes, and can be produced at a lower cost that that of glass lenses. Therefore, application of the plastic lens is rapidly spreading not only to a lens for glasses but also to the above optical lens. With this spread, in order to make the lens small and thin, it is required to increase a refractive index of the material itself, or to stabilize an optical refractive index in relation to thermal expansion and temperature change. Various approaches have been made in order to improve the optical refractive index and suppress the coefficient of thermal expansion and the optical refractive index in relation to the temperature change. For example, the approach of using, as lens material, a nano composite resin in which inorganic fine particles such as metal fine particles are dispersed in a plastic resin has been made.

A refractive index and thermal stability of the optical member formed of the nano composite resin are improved typically by increasing the addition amount of the inorganic fine particles, whereas fluidity of the nano composite resin lowers. Particularly, in order to improve the refractive index, a large amount of the inorganic fine particles must be dispersed, and the fluidity of the nano composite resin lowers markedly with the recent demand for increase in refractive index. Therefore, in the nano composite resin, resin fluidity necessary for injection molding is difficult to obtain, and there is fear of poor transfer of fine structure in the injection molding. Therefore, heretofore, there has been proposed a method of forming an optical member by press-molding a preform formed of the nano composite resin (refer to, for example, JP-A-2006-343387).

In order to prepare a preform from the nano composite resin, there are the following methods.

(1) The inorganic fine particles are directly mixed and melted with the thermoplastic resin to be injection-molded (refer to, for example, JP-A-2006-343387).
(2) After the inorganic fine particles are mixed with the thermoplastic resin in a solvent, the solvent is put into a mold such as a metal mold or a ceramic mold and is heated to be removed (refer to, for example, JP-A-2003-147090 and JP-A-2002-047425).

In JP-A-2006-343387, a preform is heat-press molded to form a desired optical member. Here, since the nano composite resin is poor in fluidity, in case that adhesive interfaces between the nano composite resins are formed in heat-press molding, the mixture of the nano composite resins at the interfaces is not sufficient. As a result, there is fear that poor welding may occur, which results in optical defects. Therefore, it is necessary to avoid the adhesive interfaces between the nano composite resins from forming in heat-press molding.

In manufacturing a preform, according to the method (1), at even a high temperature, the fluidity of the nano composite resin necessary for injection molding is not obtained, so that molding becomes difficult. In addition, the fine particles coagulate partially, so that the dispersion density does not become constant and the desired optical properties (transparency and refractive index) can not be obtained. Further, since the optical member requires high quality, the material which has remained in a runner in the injection molding is not reused and discarded, because of prevention of deterioration in quality of the optical member. Therefore, the amount of the loss of the supplied material is comparatively much, which prevents cost in manufacturing a preform from being reduced.

According to the above solution method (2) of which a casting method is representative, the above problem (1) can be solved. However, in the conventional solution method, it is not considered that the shape of the preform is made closely resemblant to the shape of the desired optical member. For example, even a preform which is used as the pre-finish product of the biconvex lens is not formed in the shape of a nearly biconvex curved surface. In order to obtain a preform having the nearly biconvex curved surface, it is necessary to cut bulk material, which is a factor of obstruction in reduction of preform manufacturing cost.

### DISCLOSURE OF THE INVENTION

An object of the invention is to provide a manufacturing method and apparatus of a preform for an optical member in which an optical member that is excellent in optical characteristic can be inexpensively formed using nano composite resin, a preform manufactured by the method, and an optical member formed from the preform.

The above object of the invention can be achieved by the following preform manufacturing methods.

(1) A method for manufacturing a preform from a nano composite resin that includes a thermoplastic resin containing inorganic fine particles, the preform being a pre-finish product of an optical member having an optical surface formed by press molding,

the method comprising:

supplying a solution including the nano composite resin and a solvent into a mold which has an approximate optical surface closely resembling the optical surface and an opening to an atmosphere; and

evaporating the solvent while a shape of the approximate optical surface is kept, to solidify the solution.

(2) The method according to (1), wherein the solution is supplied so as to include the nano composite resin in such an amount that the preform can be formed.
(3) The method according to (1) or (2), wherein

the optical member has a first optical surface and a second optical surface on upper and lower sides thereof;

the mold includes a lower mold and an upper mold inserted into the lower mold;

the low mold has a first approximate optical surface configuration on a bottom surface thereof, the first approximate optical surface configuration being for forming a first approximate optical surface closely resembling the first optical surface;

the upper mold has a second approximate optical surface configuration on an surface of the upper mold which is opposed to the bottom surface of the lower mold, the second approximate optical surface configuration being for forming a second approximate optical surface closely resembling the second optical surface;

the solution is supplied into the lower mold; and

the upper mold is inserted into the lower mold before the solution is solidified.

(4) The method according to (3), wherein

each of the first optical surface and the second optical surface is a convex surface; and

each of the first approximate optical surface configuration and the second approximate optical surface configuration is a concave surface.

(5) The method according to (1) or (2), wherein

the optical member has a first optical surface and a second optical surface on upper and lower sides thereof, each of the first optical surface and the second optical surface being a convex surface;

the mold has a convex surface configuration on a surface of the mold, the convex surface configuration being for forming a first approximate optical surface closely resembling the first optical surface; and

the solution is bulged by a surface tension acting between the solution overflowing from the convex surface configuration and the surface of the mold, so as to form a second approximate optical surface closely resembling the second optical surface.

(6) The method according to (5), wherein the solvent is evaporated while a fluidity of a surface layer of the second approximate optical surface is kept.
(7) The method according to (6), wherein when a total weight of the solvent before evaporating is taken as M by g and an evaporation speed of the solvent is taken as E by g/h, M and E satisfy E≦0.0014M.
(8) The method according to any one of (1) to (7), wherein

the solvent is evaporated from the opening until the solution becomes a gel body; and

the gel body is taken out from the mold, and the solvent is further evaporated until a residual solvent amount comes to 5000 ppm or less.

(9) The method according to any one of (1) to (8), wherein a contact angle θ between the mold and water is 35°<θ<180°.

According to the preform manufacturing method of (1), the approximate optical surface closely resembling the optical surface is formed in the preform. Due to this, poor welding can be prevented and the optical properties of the formed optical member can be improved. Further, by using a solution method, the inorganic fine particle in the nano composite resin can be uniformly dispersed and the optical properties of the optical member as well as the preform can be improved.

According to the preform manufacturing method of (2), the optical member can be surely formed.

According to the preform manufacturing method of (3), the preform suitable as a pre-finish product for an optical member in which the optical surfaces are formed on its lower and upper sides can be manufactured. Further, the area of the opening to an atmosphere can be set to be large, so as to reduce the time of solidification, and thus reduction in cost can be achieved due to its efficiency.

According to the preform manufacturing method of (4), the approximate optical surfaces are fowled on lower and uppers sides of the preform. In heat-press molding such a preform into an optical member, the heat-press molding proceeds in the center of the surface of the metal molding for heat-press molding. Therefore, it is easy to put air into the outside of the mold and to prevent air bubbles from generating, and yield ratio can be improved.

According to the preform manufacturing method of (5), the approximate optical surfaces are formed on lower and uppers sides of the preform. In heat-press molding such a preform into an optical member, the heat-press molding proceeds in the center of the surface of the metal molding for heat-press molding. Therefore, it is easy to put air into the outside of the mold and to prevent air bubbles from generating, and yield ratio can be improved. Further, the second approximate optical surface can be formed by the action of the surface tension, thereby to simplicate the manufacturing apparatus to reduce the cost.

According to the preform manufacturing method of (6), the second approximate optical surface doubles with the atmosphere opening surface, and by evaporating the solvent while keeping the fluidity of a surface layer of the second approximate optical surface, the shape of the second approximate optical surface can be kept against the volume reduction due to the evaporation of the solvent.

According to the preform manufacturing method of (7), the solvent can be evaporated while keeping the fluidity of a surface layer of the second approximate optical surface. More preferably, E≦0.0007M and the solvent can be surely evaporated while keeping the fluidity of a surface layer of the second approximate optical surface.

According to the preform manufacturing method of (8), the solvent is evaporated until the residual solvent amount comes to 5000 ppm or less which is such an amount that the size change is within a specific amount, and it is possible to mold the optical member from the nano composite resin which was conventionally difficult for molding. Further, the amount of the residual solvent is preferably 3000 ppm or less, more preferably 1500 ppm or less, and most preferably 1000 ppm or less. In case that the amount of the residual solvent is from 1500 to 3000 ppm, air bubble generation is suppressed by temperature control. In case that the amount of the residual solvent is 1000 ppm or less, the air bubble generation is suppressed without controlling the temperature, so that the optical properties can be improved. Further, after the shape of the solution can be kept as a gel body, the gel body is taken out from the mold thereby to obtain a large atmosphere opening surface, and the solidification time can be shorten to reduce the cost.

According to the preform manufacturing method of (9), the mold release property of the preform or the gel body can be improved.

(10) An apparatus for manufacturing a preform from a nano composite resin that includes a thermoplastic resin containing inorganic fine particles, the preform being used as a pre-finish product of an optical member having a first optical surface and a second optical surface on upper and lower sides thereof which are formed by press-molding,

the apparatus comprising a mold which has a first approximate optical surface closely resembling the first optical surface, a second approximate optical surface closely resembling the second optical surface, and an opining to an atmosphere open, and into which a solution including the nano composite resin is supplied,

wherein

the mold includes a lower mold and an upper mold inserted into the lower mold;

the lower mold has a first approximate optical surface configuration on a bottom surface thereof, the first approximate optical surface configuration being for forming the first approximate optical surface; and

the upper mold has a second approximate optical surface configuration on an surface of the upper mold which is opposed to the bottom surface of the lower mold, the second approximate optical surface configuration being for forming a second approximate optical surface closely resembling the second optical surface.

(11) The apparatus according to (10), wherein

each of the first optical surface and the second optical surface is a convex surface; and

each of the first approximate optical surface configuration and the second approximate optical surface configuration is a concave surface.

(12) An apparatus for manufacturing a preform from a nano composite resin that includes a thermoplastic resin containing inorganic fine particles, the preform being used as a pre-finish product of an optical member having a first optical surface and second optical surface on upper and lower sides thereof, each of the first optical surface and the second optical surface being a convex surface,

the apparatus comprising a mold, which has a first approximate optical surface closely resembling the first optical surface, a second approximate optical surface closely resembling the second optical surface, and an opening to an atmosphere, and into which solution including the nano composite resin is supplied,

wherein the mold has a convex surface configuration on a surface thereof, the convex surface configuration being for forming the first approximate optical surface, and the mold acts a surface tension between the solution overflowing from the convex surface configuration and the mold in such a manner that the solution is bulged to form the second approximate optical surface.

According to the preform manufacturing apparatus of (10), the preform suitable as a pre-finish product for an optical member in which the optical surfaces are formed on its lower and upper sides can be manufactured.

According to the preform manufacturing apparatus of (11), the approximate optical surfaces are formed on lower and uppers sides of the preform. In heat-press molding such a preform into an optical member, the heat-press molding proceeds in the center of the surface of the metal molding for heat-press molding. Therefore, it is easy to put air into the outside of the mold and to prevent air bubbles from generating, and yield ratio can be improved.

According to the preform manufacturing apparatus of (12), the approximate optical surfaces are formed on lower and uppers sides of the preform. In heat-press molding such a preform into an optical member, the heat-press molding proceeds in the center of the surface of the metal molding for heat-press molding. Therefore, it is easy to put air into the outside of the mold and to prevent air bubbles from generating, and yield ratio can be improved. Further, the second approximate optical surface can be formed by the action of the surface tension, thereby to simplicate the manufacturing apparatus to reduce the cost.

The above object of the invention can be achieved by the following preform.

(13) A preform manufactured by a method according to any one of (1) to (9) above.

According to the preform of (13), the approximate optical surface closely resembling the optical surface is formed in the preform. Due to this, poor welding can be prevented and the optical properties of the formed optical member can be improved. Further, by using a solution method, the inorganic fine particle in the nano composite resin can be uniformly dispersed and the optical properties of the optical member as well as the preform can be improved.

The above object of the invention can be achieved by the following optical members.

(14) An optical member formed by press-molding a preform according to (13).
(15) The optical member according to (14), which is a lens.

According to the optical member of (14), the optical member has excellent optical characteristics and can be manufactured in low cost.

According to the optical member of (15), a lens having a high refractive index and excellent optical characteristics can be readily prepared.

### ADVANTAGEOUS EFFECTS

According to embodiments of the invention, it is possible to provide a manufacturing method and apparatus of a preform for an optical member in which an optical member that is excellent in optical characteristic can be inexpensively formed using nano composite resin, a preform manufactured by its method, and an optical member formed from the preform.

### BRIEF DESCRIPTION OF THE DRAWINGS

FIG. 1 is a longitudinal sectional view showing a schematic constitution of a preform molding apparatus in an embodiment of the invention;

FIG. 2 is a longitudinal sectional view showing a schematic constitution of a compression molding apparatus in the embodiment of the invention;

FIG. 3 is an explanatory view showing schematically a step of molding a preform from a solution including a nano composite resin by the preform molding apparatus in FIG. 1;

FIG. 4 is an explanatory view showing schematically a step of molding an optical member from the preform by the compression molding apparatus; and

FIG. 5 is a graph showing weight change of the solution including the nano composite resin in the optical member molding process with the passage of time;

FIG. 6 is a longitudinal sectional view showing a schematic constitution of a preform manufacturing apparatus according to a second embodiment of the invention;

FIG. 7 is an explanatory diagram showing schematically a process of manufacturing a preform from a solution including nano composite resin by the preform manufacturing apparatus in FIG. 6;

FIG. 8 is a longitudinal sectional view showing a schematic constitution of a preform manufacturing apparatus according to a third embodiment of the invention;

FIG. 9 is an explanatory diagram showing schematically a process of manufacturing a preform from a solution including nano composite resin by the preform manufacturing apparatus in FIG. 8; and

FIG. 10 is a sectional view of a preform to be manufactured by the preform manufacturing apparatus in FIG. 8,

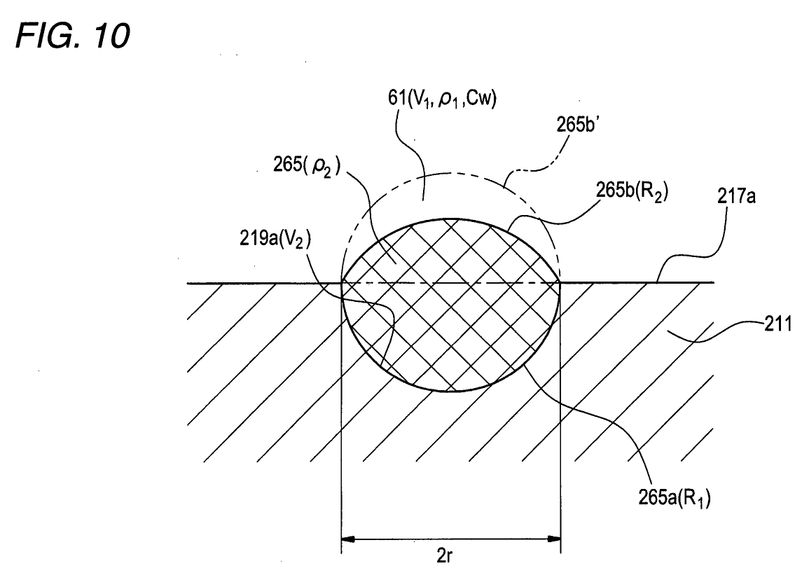

wherein description of some reference numerals and signs are set forth below.
11 Container-type lower mold
12 Opening to atmosphere (Atmosphere open surface)
13 Convex upper mold
17 Cylindrical container
17a Bottom surface
19 Core
19a First approximate optical surface configuration
45 Upper mold (approximate optical surface configuration forming member)
45a Second approximate optical surface configuration
51 Upper mold
51a Optical function transfer surface
53 Lower mold
53a Optical function transfer surface
61 Solution
65 Light-transmissible optical member preform (solid nano composite resin)
65a Approximate optical surface of preform
65b Approximate optical surface of preform
67 Optical member (lens)
67a One of approximate optical surface surfaces (finished surface) of optical member
67b The other of approximate optical surfaces (finished surface) of optical member
100 Preform molding apparatus (first molding unit, optical member molding apparatus)
200 Compression molding apparatus (second molding unit, optical member molding apparatus)

### BEST MODE FOR CARRYING OUT THE INVENTION

An exemplary embodiment of an optical member molding method and an optical member molding apparatus according to the invention will be described below in detail with reference to drawings.

An optical member molding apparatus in an embodiment of the invention includes a preform molding apparatus which executes a former half part of optical member molding (molding of a preform from solution including a nano composite resin), and a compression molding apparatus which executes a latter half part thereof (molding of an optical member from the preform).

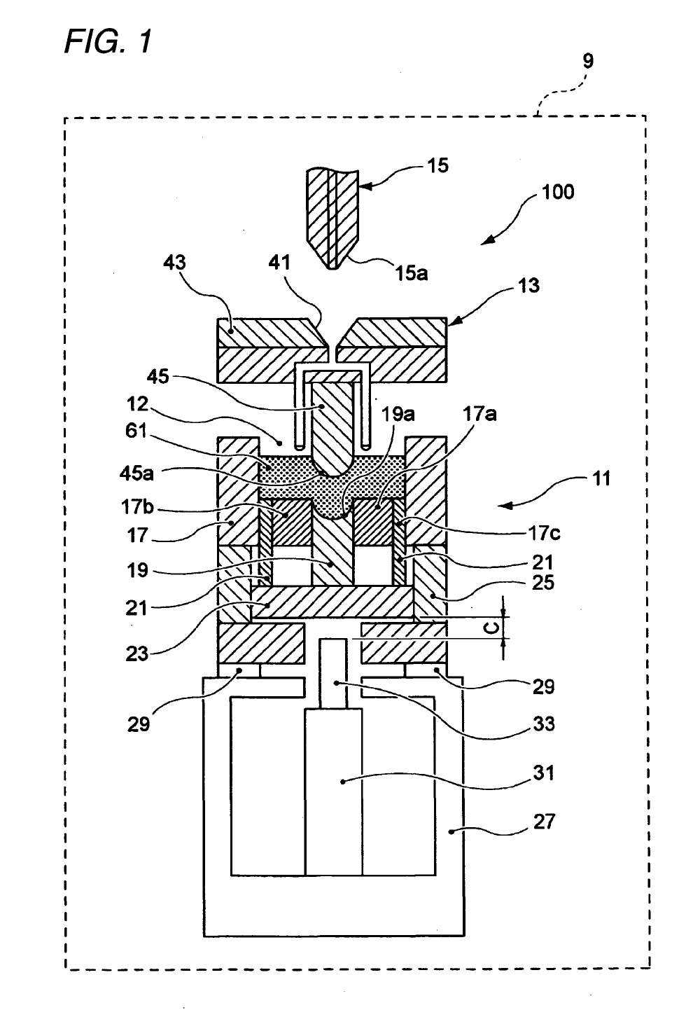

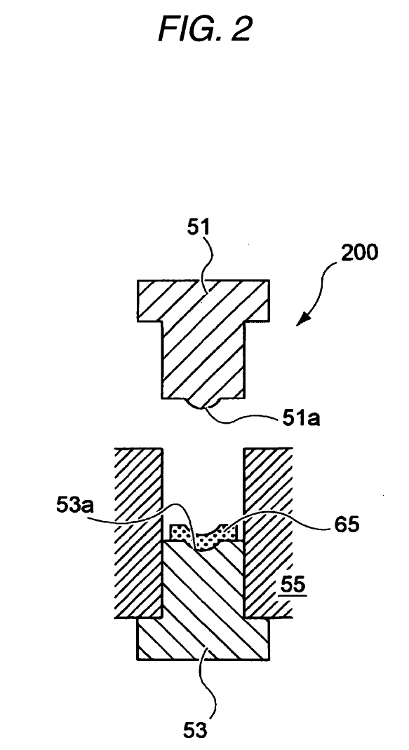

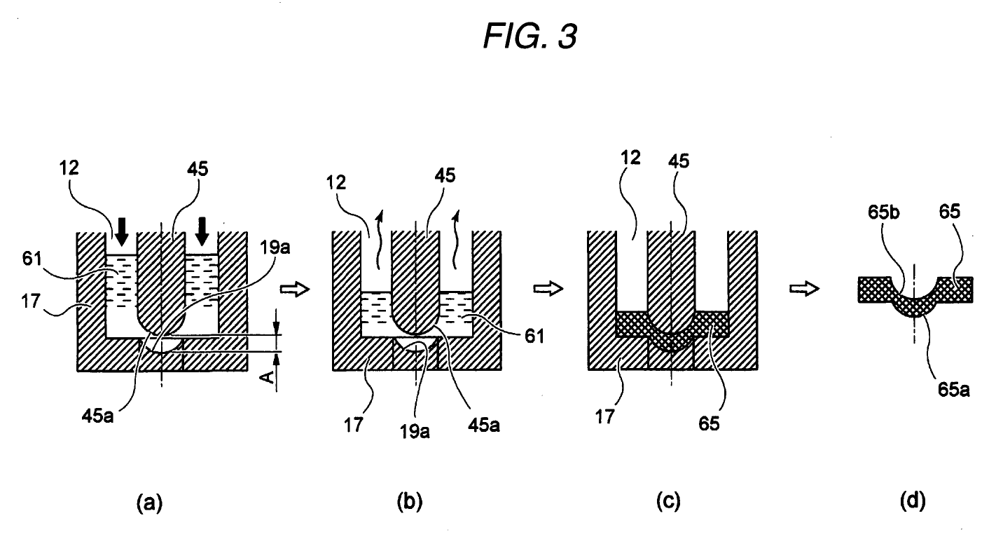

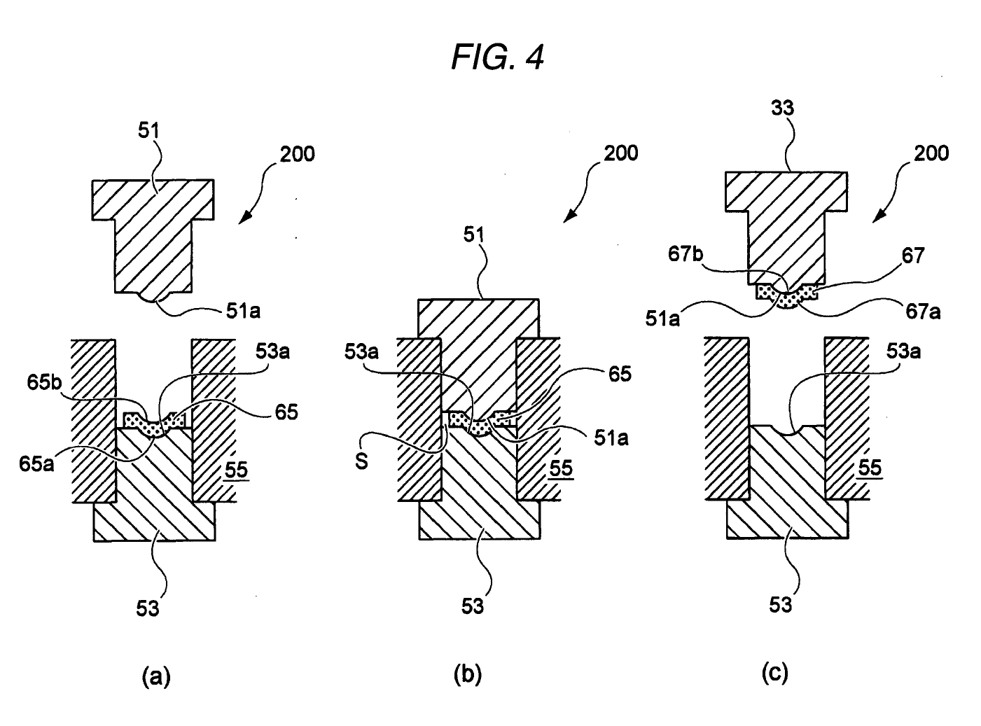

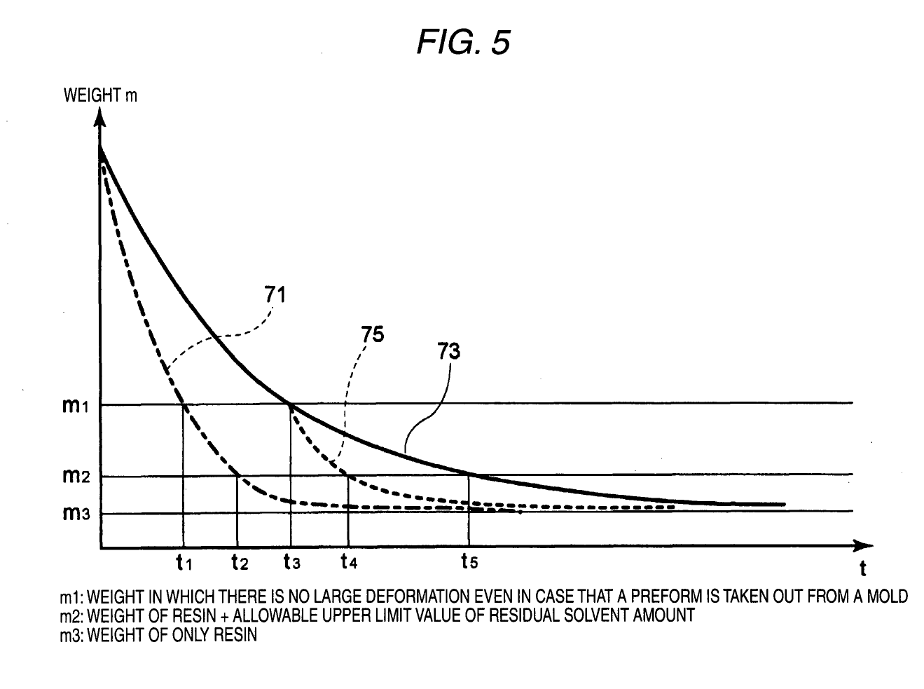

FIG. 1 is a longitudinal sectional view showing the schematic constitution of the preform molding apparatus in the embodiment of the invention, FIG. 2 is a longitudinal sectional view showing the schematic constitution of the compression molding apparatus in the embodiment of the invention, FIG. 3 is an explanatory view showing schematically a step of molding a preform from a solution including a nano composite resin by the preform molding apparatus in FIG. 1, FIG. 4 is an explanatory view showing schematically a step of molding an optical member from the preform by the compression molding apparatus in FIG. 2, and FIG. 5 is a graph showing weight change of the solution in the optical member molding step with the passage of time.

As shown in FIG. 1, a preform molding apparatus 100 which is a first molding unit includes a container-shaped lower mold 11, a convex upper mold 13, and a dispenser device 15, and is arranged in a drying room 9. The container-shaped lower mold 11 includes a nearly cylindrical container 17 which has an atmosphere open surface 12 on its surface thereby to be opened to the outside, a core 19 which is fitted into a core hole 17b provided in the center of a bottom surface 17a of the cylindrical container 17, and an ejector pin 21. Further, in accordance with the configuration of the preform, the convex upper mold 13 may be formed concavely. Also in this case, the invention can be executed. The bottom surface 17a out of the range of the core hole 17b molds a flange portion of the preform.

On the upper surface of the core 19, a first approximate optical surface configuration 19a which is formed in the shape of a semispherically concave surface is formed. The first approximate optical surface configuration 19a is transferred to a light-transmissible optical member preform 65 described later, whereby one (convex surface) 65a of approximate optical surfaces is formed (refer to FIG. 3(d)). The configuration of the light-transmissible optical member preform 65 is, as described later, remolded by a compression molding apparatus 200. Therefore, as long as the configuration of the approximate optical surface 65a is close to the configuration of an optical member 67 that is a finished product, the first approximate optical surface configuration 19a does not require comparatively accuracy. Accordingly, the manufacturing cost of a mold is inexpensive. Further, in accordance with the configuration of the preform, the first approximate optical surface configuration 19a may be formed convexly. Also in this case, the invention can be executed.

The ejector pin 21 is fixed to a movable plate 23 which can move in a up-down direction, and fits slidably into a pin hole 17c provided in the bottom surface 17a of the cylindrical container 17. Further, onto the upper surface of the movable plate 23, the core 19 is fixed and moves in the up-down direction together with the ejector pin 21 with the movement of the movable plate 23.

The cylindrical container 17 is placed through a spacer 25 on a weight sensor 29 arranged on the upper surface of a base 27. The weight sensor 29, which is, for example, a load cell that can detect the loaded weight as strain of a sensor element with good accuracy, measures the weight of the container-shaped lower mold 11 (including the spacer 25) and the weight of a solution 61 including a nano composite resin supplied into the container-shaped lower mold 11.

Below the movable plate 23, a cylinder 31 is arranged on the base 27 with a piston 33 opposed to the movable plate 23. When the piston 33 is pulled into the cylinder 31, a clearance C is formed between the piston 33 and the movable plate 23, whereby contact between the piston 33 and the movable plate 23 is prevented. Accordingly, the weight sensor 29 can measure the weights of the container-shaped lower mold 11 and the solution 61.

The convex upper mold 13 includes a plate-shaped member 43 having a solution supply hole 41, and a nearly columnar upper mold 45 which is an approximate optical surface forming member that protrudes from the lower surface of the plate-shaped member 43 downward and fixed on the lower surface of the plate-shaped member 43. The convex upper mold 13 is movable in the up-down direction in relation to the container-shaped lower mold 11. The upper mold 45 has on its lower surface a second approximate optical surface configuration 45a which is formed in the shape of a semispherically convex surface. The second approximate optical surface configuration 45a is transferred to the light-transmissible optical member preform 65 described later, whereby the other (concave surface) 65b of approximate optical surfaces is formed (refer to FIG. 3(d)). The accuracy of the second approximate optical surface configuration 45a, by the reason similar to that in case of the first approximate optical surface configuration 19a, may be comparatively rough. The upper mold 45 is arranged in a state where an axis of the upper mold 45 coincides with an axis of the core 19.

The material used for the container-shaped lower mold 11 (the cylindrical container 17, the core 19, and the ejector pin 21) and the convex upper mold 13 (the upper mold 45), as long as it can be worked in necessary surface roughness (which does not need to be mirror surface), is not be particularly limited. For example, metal material such as stainless steel or STAVAX, or resin material such as ceramic or Teflon can be used.

The dispenser device 15, which has a nozzle-shaped leading end portion 15a, is connected through a tube to a solution tank (not shown) for storing the solution 61 including the nano composite resin. The leading end portion 15a is movable in an approach direction to or a separation direction from the plate-shaped member 43. By bringing the leading end portion 15a into contact with the solution supply hole 41 of the plate-shaped member 43, the dispenser device 15 supplies the solution 61 including the nano composite resin to the container-shaped lower mold 11.

Further, when the solution is supplied, it is required to make the density of the solution constant. The solution is supplied under an atmosphere of saturation vapor pressure.

The compression molding apparatus 200 which is a second molding unit, as shown in FIG. 2, has three molds including an upper mold 51, a lower mold 53 and an external mold 55. The upper mold 51 and the lower mold 53 fit into the external mold 55, and can be moved relatively by a not-shown drive device in a direction which they approach each other or separate from each other. On the upper surface of the lower mold 53, an optical function transfer surface 53a subjected to mirror finishing in order to transfer an approximate optical surface (finished surface) 67a to an optical member 67 has been formed. Further, on the lower surface of the upper mold 51, an optical function transfer surface 51a subjected to mirror finishing in order to transfer an approximate optical surface (finished surface) 67b to the optical member 67 has been formed. Further, accuracy of the mirror surface in the optical function transfer surface 53a and the optical function transfer surface 51a is Ra 30 nm or less in surface rough. Around the lower mold 53 or the external mold 55, a coil (not shown) is wound, which can set the mold temperature at a predetermined temperature within a range of from 30 to 400° C. by high-frequency induction heating. The upper mold 51 and the lower mold 53, after setting the light-transmissible optical member preform 65 between them, are heated by high-frequency induction heating, thereby to increase the temperature of the light-transmissible optical member preform 65 up to a predetermined temperature. Thereafter, the upper mold 51 and the lower mold 53 compress the light-transmissible optical member preform 65 while holding and heating it, thereby to mold the preform 65 into an optical member 67 which is a finished product.

Though the description of constituent features described below is made on the basis of the typical embodiment of the invention, the invention is not limited to such the embodiment.

The operation in the embodiment will be described. First, a former half process of molding a preform from a solution including a nano composite resin will be described.

As shown in FIGS. 1 and 3, after the piston 33 of the cylinder 31 has been moved down to separate the piston 33 from the movable plate 23, the weight of the container-shaped lower mold 11 in a vacant state (including the spacer 25) is measured by the weight sensor 29. Next, the leading end portion 15a of the dispenser device 15 is brought into contact with the solution supply hole 41 of the plate-shaped member 43, and the solution 61 including the weight of nano composite resin previously set in accordance with an optical member 67 to be molded is supplied to the container-shaped lower mold 11. Thereafter, the weight is measured again by the weight sensor 29 to confirm the supply of the predetermined weight of solution 61 (solution supply step).

At this time, it is preferable that the solution 61 including the nano composite resin does not enter a clearance between the ejector pin hole 17c and the bottom surface 17a. Accordingly, it is necessary to set the density of the solution at 5 wt. % or more. Further, from viewpoints of easiness in handling and time necessary for drying, the density of the solution is preferably from 10 to 60 wt % and more preferably from 20 to 50 wt %. This case is advantageous on the manufacture.

Next, the upper mold 45 is moved down thereby to let its leading end portion enter the solution 61, and a distance between the first approximate optical surface configuration 19a of the core 19 and the second approximate optical surface configuration 45a of the upper mold 45 is fixed to a predetermined distance A. The predetermined distance A is determined by the thickness of the optical member 67 to be molded, and set larger a little than the thickness of the optical member 67 considering deformation in a second evaporation step described later and the compression amount by the compression molding apparatus 200 (refer to FIG. 3(a)).

The environment in the drying room 9 in which the preform molding apparatus 100 is installed is set as follows: a density of the supplied nano composite resin is 36 wt %, A=1 mm, a diameter of the upper mold is 8 mm, an inner diameter of the cylindrical container is 10 mm, a distance between the bottom surface 17a and the liquid surface is 2.8 mm, a temperature is from 30 to 80° C., and a degree of vacuum is from 100 to 10⁻¹ Pa. In case that drying is performed for six hours or more under this environment, as shown in FIGS. 3B and 3C, the solvent in the solution 61 evaporates from the atmosphere open surface 12 of the cylindrical container 17, gradually hardens, and becomes soon a light-transmissible optical member preform 65 in a solid state where the approximate optical surface configuration can be kept. Hereby, the first approximate optical surface configuration 19a of the core 19 and the second approximate optical surface configuration 45a of the upper mold 45 are transferred to the preform 65 as approximate optical surfaces 65a and 65b (first evaporation step). The solidified state, that is, whether or not solidification has been performed up to the state where the approximate optical surface configuration can be kept can be readily judged visually, by touch with a finger, or from the reduction weight obtained by subtracting the present weight measured by the weight sensor 29 from the weight before start of the first evaporation step.

The cylinder 31 is operated, and the core 19 and the ejector pin 21 are pushed up through the movable plate 23 by the piston 33, thereby to take out a solid nano composite resin (light-transmissible optical member preform) 65 from the cylindrical container 17. The solid nano composite resin 65 is left in the drying room 9 which is kept at a temperature of from 30 to 120° C. and at a degree of vacuum of from 100 to 10⁻¹ Pa. Until the dimensional change becomes within the predetermined amount, that is, until the residual solvent amount of the light-transmissible optical member preform 65 comes to an allowable upper limit value or less, the solvent is further evaporated (second evaporation step)

In the second evaporation step, the allowable value of the residual solvent amount is 5000 ppm or less, preferably 3000 ppm or less, more preferably 1500 ppm or less, and most preferably 1000 ppm or less. In case that the allowable value is 5000 ppm or less, air bubbles may be generated by heat in the pressing time. However, in case that the allowable value is from 1500 to 3000 ppm, the generation of the air bubbles is suppressed by the temperature control. In case that the allowable value is 1000 ppm or less, the generation of the air bubbles is suppressed, so that a stable quality can be obtained.

By taking out the light-transmissible optical member preform 65 from the cylindrical container 17, the area exposed to the outside becomes greatly wide, so that there is a big leap in reduction of the evaporation time, compared with the case where the preform 65 is evaporated in the state where it is put in the cylindrical container 17.

Next, a latter half process of molding an optical member that is a finished product from the light-permissible optical member preform will be described with reference to FIG. 4.

As shown in FIG. 4, the light-transmissible optical member preform 65 which has evaporated until the residual solvent amount comes to the allowable upper limit value or less is molded into an optical member 67 that is a finished product by the compression molding apparatus 200. In a state where the upper mold 51 and the lower mold 53 are spaced from each other, the light-transmissible optical member preform 65 is put on the lower mold 53 arranged in the external mold 55. As shown in FIG. 4(b), the upper mold 51 is moved toward the lower mold 53, and the preform 65 is pressed between the upper mold 51 and the lower mold 53 while being heated. While the approximate optical surfaces 65a and 65b of the light-transmissible optical member preform 65 are plastically being deformed, the preform 65 is completely dried. As the compression molding condition, for example, the mold temperature is set in a range of from (Tg of the nano composite material) to (Tg+150° C.), and preferably in a range of from Tg to (Tg+100° C.). The press in the press-molding time is performed in a state where the press power is in a range of from 0.005 to 100 kg/mm², preferably in a range of from 0.01 to 50 kg/mm², and still more preferably in a range of from 0.05 to 25 kg/mm². The press speed is from 0.1 to 1000 kg/sec.; and the press time is from 0.1 to 900 sec., preferably from 0.5 to 600 sec., and more preferably from 1 to 300 sec. Further, the press start timing may be immediately after heating, or after a fixed time for the purpose of uniform heating (to make the temperature of the preform 65 uniform to the inside thereof).

At this time, a space S necessary for the light-transmissible optical member preform 65 to spread outward in the radius direction is provided among the molds (refer to FIG. 4(b)). Therefore, by reduction in volume produced by compressing the light-transmissible optical member preform 65 in the axial direction (up-down direction in the figure), the light-transmissible optical member preform 65 can spread outward in the radius direction, so that molding is not obstructed. Hereby, the thickness of the optical member 67 can be made with good accuracy in accordance with the design value, so that desired optical characteristics are obtained.

Next, the light-transmissible optical member preform 65 is cooled under the pressurized state, and the configurations of the optical function transfer surfaces 51a and 53a are transferred to the optical member 67 to form the approximate optical surfaces 67a, 67b like a mirror surface. Thereafter, as shown in FIG. 4(c), the upper mold 51 and the lower mold are opened, and the optical member 67 that is a product obtained by compression molding is taken out.

The temperature of the mold when the preform 65 is put in the compression-molding apparatus may be higher or lower than the glass transition temperature Tg. However, it is preferable that the mold temperature is higher, because heating of the preform 65 is completed in a short time. Further, since the preform 65 shrinks in the cooling time, pressing is performed in accordance with progress degree of cooling, whereby the mold shape (optical function transfer surface 51a, 53a) can be transferred with higher accuracy.

One of the objects of the invention is to enable molding of the optical member 67 from the solution 61 including the nano composite resin in a short time. It takes much time of this molding time to mold the light-transmissible optical member preform 65 from the solution 61. Accordingly, it is effective, on reduction of the total molding time, to reduce the time until molding of this light-transmissible optical member preform 65 is completed.

As shown in FIG. 5, the weight of the solution 61 including the nano composite resin decreases together with evaporation of the solvent. A curve 71 shown by dashed dotted lines in the figure shows a relation between time and weight when the solvent is evaporated in a state where the solution 61 including the nano composite resin is not put in the container (for example, in a state where the solution 61 is poured on a flat plate). Further, a curve 73 shown by a solid line shows a relation between time and weight when the solvent is evaporated in a state where the solution 61 is put in the container.

When the solvent is evaporated in the state where the solution 61 is not put in the container, the surface area contributing to the evaporation is large. Therefore, the weight decreases rapidly as shown by the curve 71, and in a short time t1, the weight of the solution 61 comes to weight m1 in the state where the approximate optical surface configuration can be kept. Further, in a time t2, the weight of the solution 61 comes to weight m2 in the state where the amount of residual solvent comes to the allowable upper limit value.

On the other hand, when the solvent is evaporated in the state where the solution 61 is put in the container, the surface area contributing to the evaporation becomes small area of the transverse area of the container. Therefore, it takes a long time t3 for the weight of the solution 61 to come to the weight m1 as shown by the curve 73, and further it takes an extremely long time t5 for the weight thereof to come to the weight m2, so that this evaporation is not industrially practical from a viewpoint of molding the optical member 6.

Therefore, in the invention, the solvent is evaporated in the state where the solution 61 is put in the container, up to the state where the approximate optical surface configuration can be kept (up to the weight m1) along the curve 73 (time t3), thereby to form the light-transmissible optical member preform 65 (first evaporation step). Thereafter, the preform 65 is taken out from the container, and the solvent is rapidly evaporated, as shown by a dashed line curve 75, up to the state where the amount of the residual solvent comes to the allowable upper limit value or less (up to the weight 2) (time t4)(second evaporation step). The time t4 when the second evaporation step ends is about 1/10 as large as the time t5 when the solvent is evaporated in the state where the solution 61 is put in the container, so that the molding time can be greatly reduced. The light-transmissible optical member preform 65 in which the solvent has evaporated up to the weight m2 in the time t4 is heat-compressed by the compression molding apparatus 200 and molded into the optical member 67 that is a finished product.

In the above description, immediately after the solution 61 has been supplied into the container 17, the upper mold 45 is moved downward to enter the solution 61. However, timing of supply of the solution 61 and down-movement of the upper mold 45 is limited to this. For example, the solvent is evaporated for a while in a state where the solution 61 has been supplied (the upper mold 45 is not moved down), and immediately before completion of the first evaporation step when the solution 61 is put in the semi-solid state, the upper mold 45 may be moved down. Hereby, since the solvent is evaporated from the area that is wider by the area of the upper mold 45, the evaporation time can be further reduced.

In the above embodiment, though the first approximate optical surface configuration 19a provided for the core 19 and the second approximate optical surface configuration 45a provided for the upper mold 45 mold the light-transmissible optical member preform 65 in the container 17, only the first approximate optical surface configuration 19a may mold the preform 65 for the purpose of the most basic shape of a lens, and the constitution in which the upper mold 45 is not required may be adopted.

Further, as another constitution of the method regarding this upper mold 45, such constitution may be adopted that: before the solution 61 is supplied into the container 17, the upper mold 45 is previously arranged in a predetermined position in the container 17, and the same sequential processing step is performed.

In this case, since the atmosphere exposed surface in the drying time becomes narrow, the evaporation time of the solvent becomes long. However, since the supply of the solution is executed unforcedly, without the fact that the atmosphere is trapped and put in into the solution, the degree of freedom in configuration of the upper mold 45 increases, compared with the above embodiment in which the upper mold 45 is moved and inserted into the solution.

The invention is not limited to the aforesaid embodiment, but modifications and improvements can be appropriately made. As the optical member to which the invention can be applied, there are not only various kinds of lenses but also a light guide plate of a liquid crystal display, and an optical film such as a polarizing film or a retardation film.

For example, in place of the dispenser 15, a liquid delivery type such as a peristaltic pump may delivery the solution.

In the above embodiment, the amount of the solution supply by the dispenser 15 is adjusted by the weight. However, it may be adjusted by another item than this weight, for example, the volume or the capacity. Further, the position of the solution supply nozzle is not limited to the two positions shown in FIG. 1.

Further, the direction of the solution supply is not limited to from the upper surface of the upper mold 13, but the solution may be supplied from a gap between the upper mold 13 and the lower mold 11, a side surface of the cylindrical container 17, or the bottom surface of the lower mold 11. Further, the number of the upper molds 13 and the lower molds 11 may be plural number according to the configuration of the preform 65.

Further, though the upper mold 13 is inserted vertically from the upside in FIG. 1, this direction is not limited to the vertical direction, but may be any direction. Further, the direction of the lower mold 11 may be similarly any direction. Further, though the ejectors 21 including the core 19 are located in the three positions, the number of them is not limited to three.

Further, though the weight is measured by the two sensors 29 in FIG. 1, the number of the sensors is not limited to two. Further, the kind of sensor is limited to one kind, but plural kinds of sensors may be combined.

Further, drying may be performed under other atmospheres than the vacuum atmosphere, for example, under a gas atmosphere such as a nitrogen atmosphere, a carbon dioxide atmosphere, or an atmosphere of rare gas such as argon.

Further, though the heating method of the press mold is the induction heating type by the coil in the best mode, other types than this type may be used, for example, a heat transfer type by a heater or a light heating type by a halogen lamp.

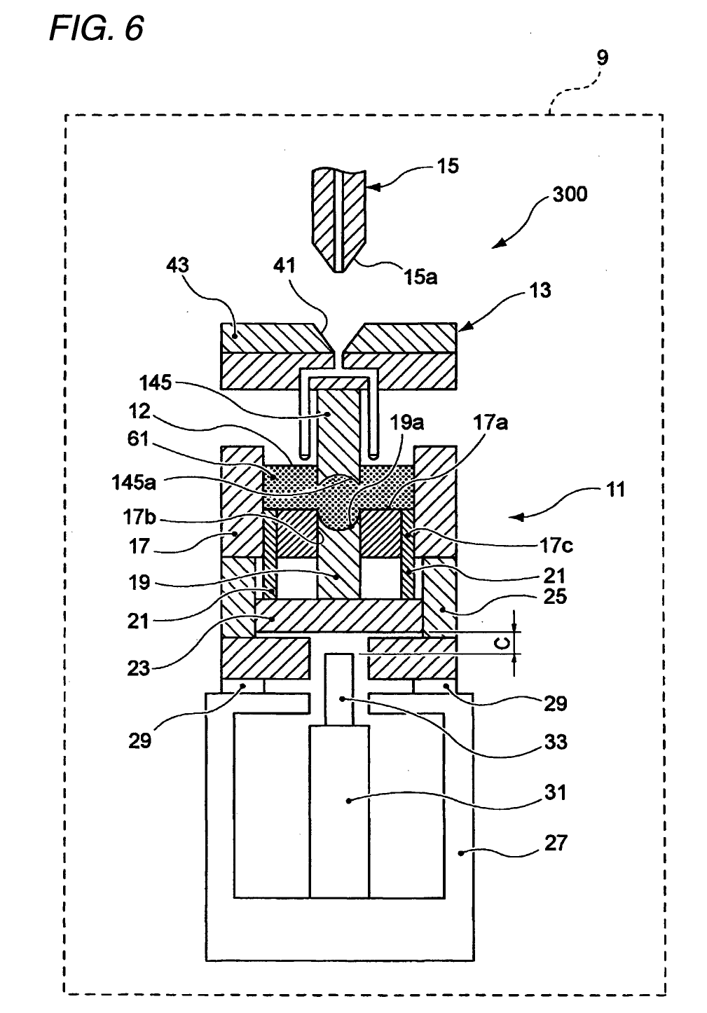

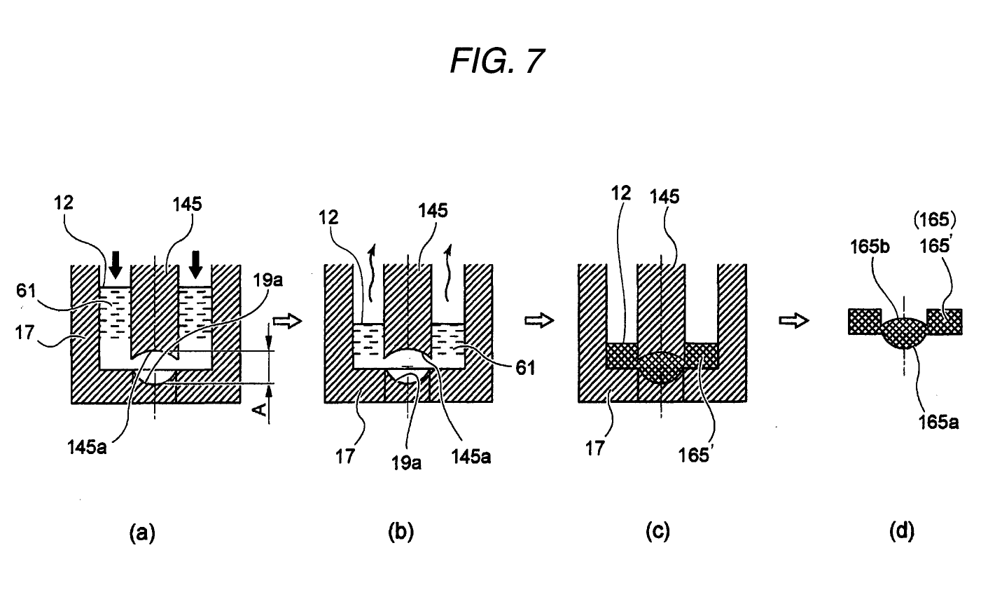

Next, with reference to FIGS. 6 and 7A-7D, a preform manufacturing apparatus according to a second embodiment of the invention will be described. FIG. 6 is a longitudinal sectional view showing a schematic constitution of the preform manufacturing apparatus according to the second embodiment of the invention. Components common to those in the above-mentioned preform manufacturing apparatus according to the first embodiment are denoted by the same reference numerals, and components similar to those in the above-mentioned preform manufacturing apparatus are denoted by corresponding reference numerals, thereby to omit or simplify their description.

As shown in FIG. 6, a preform manufacturing apparatus 300 according to this embodiment includes a convex upper mold 13 having an upper mold 145. On the lower surface of the upper mold 145, there is provided a second approximate optical surface configuration 145a which is formed in the shape of a semispherical concave curved surface. Since other components are common to those in the above-mentioned preform manufacturing apparatus 100, their description is omitted.

Referring to FIGS. 7(a)-7(d), after a solution 61 including nano composite resin has been supplied into a container-shaped lower mold 11, the upper mold 145 is moved down to dip its leading end portion in the solution 61, and then fixed when the distance between a first approximate optical surface configuration 19a of a core 19 and the second approximate optical surface configuration 145a of the upper mold 145 comes to a predetermined distance A. The solvent in the solution 61 evaporates from an atmosphere open surface 12, gels gradually, and becomes soon a gel body 165′ which can keep the shape. Hereby, the first approximate optical surface configuration 19a of the core 19 and the second approximate optical surface configuration 145a of the upper mold 145 are transferred to the gel body 165′ as approximately optical surfaces 165a and 165b (First evaporation step).

Next, a cylinder 31 is actuated, the core 19 and an ejector pin 21 are pushed up through a movable plate 23 by a piston 33, and the gel body 165′ is taken out from a cylindrical container 17 as shown in FIG. 7(d). Thereafter, the gel body 165′ is left in a dry room 9, and the solvent is further evaporated from the gel body 165′ till the dimension of the gel body 165′ changes within the predetermined amount, thereby to obtain a light-transmissible optical member preform 165 (second evaporation step).

The preform manufacturing apparatus 100 in the first embodiment manufactures the light-transmissible optical member preform 65 suitable as a pre-finish product of the optical member 67 in which one of the optical surfaces on the upper and lower sides is the convexly curved surface and the other is the concavely curved surface, in which the first approximate optical surface 65a that is the convexly curved surface is formed on one of the upper and lower sides of the light-transmissible optical member preform 65, and the second approximate optical surface 65b that is the convexly curved surface is formed on the other side. To the contrary, in the preform manufacturing apparatus 300 in this embodiment, on the upper and lower sides of the light-transmissible optical member preform 165, the approximate optical surfaces 165a and 165b that are the convexly curved surfaces are formed. The light-transmissible optical member preform 165 having such the shape is suitable as the pre-finish product of the optical member of which both sides are formed by the convexly curved surfaces.

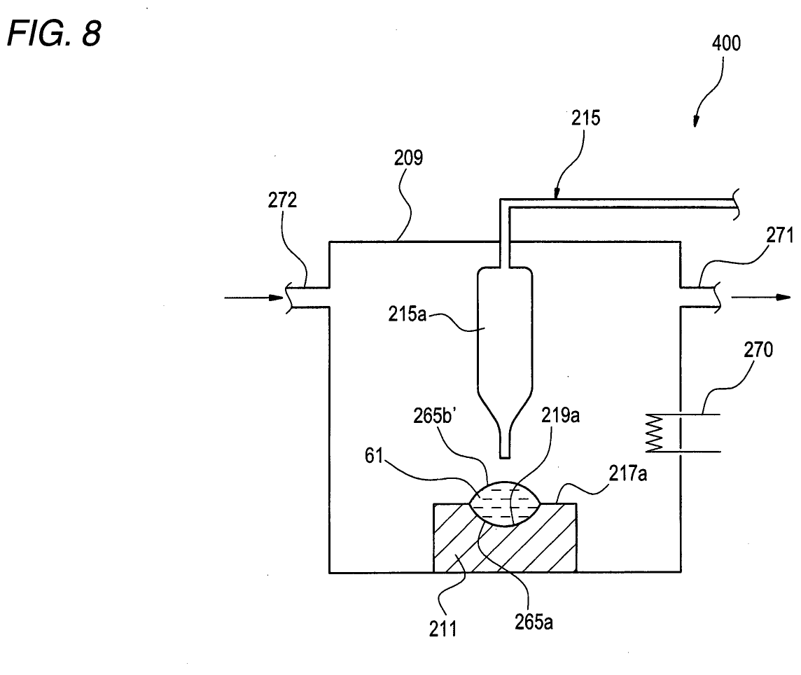

Next, referring to FIG. 8, a preform manufacturing apparatus according to a third embodiment of the invention will be described. FIG. 8 is a longitudinal sectional view showing a schematic constitution of the preform manufacturing apparatus according to the third embodiment of the invention. Components common to those in the above-mentioned preform manufacturing apparatus according to the first embodiment are denoted by the same reference numerals, and components similar to those in the above-mentioned preform manufacturing apparatus according to the first embodiment are denoted by corresponding reference numerals, thereby to omit or simplify their description.

As shown in FIG. 8, a preform manufacturing apparatus 400 in this embodiment includes a mold 211 disposed in a dry room 209, and a drop device 215 which can drop a predetermined amount of solution 61. The mold 211, as long as it has a substantially horizontal surface which faces upward, is not particularly limited. In the figure, the mold 211 is a flat plate. In the center portion of a surface 217a of the mold 211, there is formed a first approximate optical surface configuration 219a which is formed in the shape of a semispherical concave curved surface. The shape of the first approximate optical surface configuration 219a is transferred to a light-transmissible optical member preform 265 described later, thereby to form one approximate optical surface (first approximate optical surface) 265a which is a convexly curved surface. Since the light-transmissible optical member preform 265 is molded again by a compression molding apparatus, the first approximate optical surface configuration 219a does not require comparative accuracy because the shape of the approximate optical surface 265a may be any shape as long as it closely resembles the shape of the corresponding optical surface of an optical member that is a finished product. Accordingly, the manufacturing cost of the mold is inexpensive.

As the drop device 215, for example, a precision dispenser suited for liquid measurement, a syringe, and a dispensing burette can be appropriately used. A leading end portion 215a of the drop device 215, formed in the shape of a nozzle is disposed in the dry room 209 so as to face the first approximate optical surface configuration 219a of the mold 211, and is connected through a tube to a solution tank (not shown) which stores the solution 61 including nano composite resin therein. The drop device 215 supplies the solution 61 including the nano composite resin from the leading end portion 215a to the first approximate optical surface configuration 219a of the mold 211.

In the dry room 209, there are provided a gas concentration meter 270 which measures a steam concentration in atmosphere of the solvent included in the solution 61, an exhaust duct for exhausting the atmosphere in the room, and an intake duct for supplying the solvent which has vaporized into the room. The gas concentration meter 270 is connected to a not-shown control unit. The control unit, on the basis of a detection value by the gas concentration meter 270, controls opening of the exhaust duct 271 and the intake duct 272, and an exhaust/intake means such as a pump provided for the exhaust duct 271 and the intake duct 272, thereby to keep the steam concentration of the solvent in the dry room 209 at a predetermined concentration.

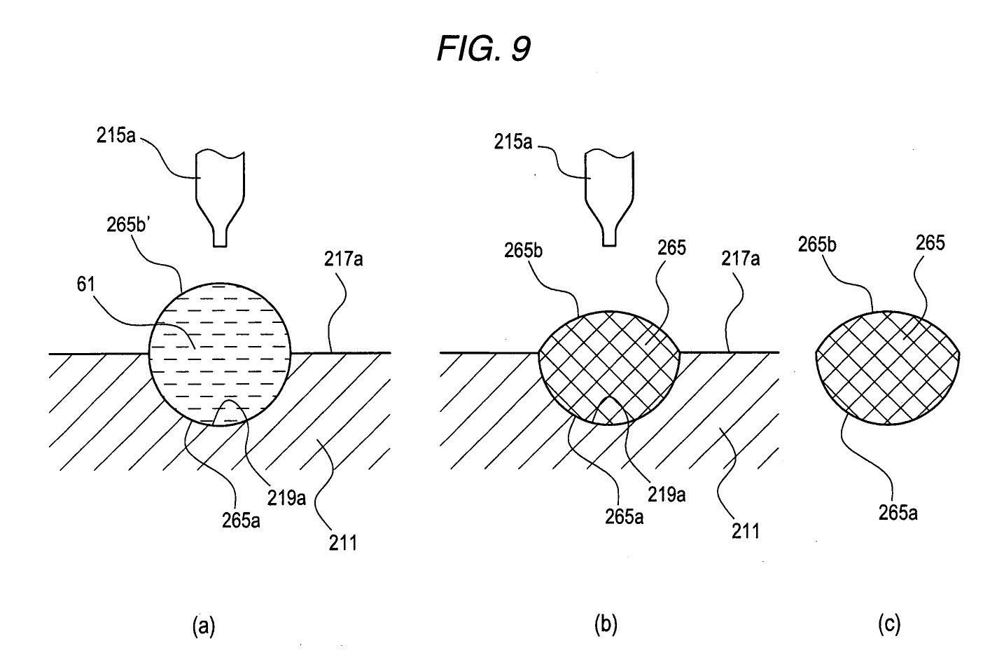

With reference to FIG. 9, a preform manufacturing method in the embodiment will be described. A light-transmissible optical member preform 265 to be manufactured by the preform manufacturing method in the embodiment is used as a pre-finish product of an optical member having on both sides convexly curved surfaces.

As shown in FIG. 9(a), the solution 61 including the nano composite resin, of which the amount is previously determined in accordance with an optical member to be molded, is supplied to the first approximate optical surface configuration 219a of the mold 211. The amount of the solution 61 to be supplied is larger than the volume of the first approximate optical surface configuration 219a formed in the shape of the concavely curved surface, and the solution 61 overflowing from the first approximate optical surface configuration 219a bulges by surface tension acting between the overflowing solution and the surface of the mold 211 to make a convexly curved configuration. A surface 265′ bulged in the shape of the convexly curved surface by this surface tension is a surface which will become a second approximate optical surface 265a in the light-transmissible optical member preform 265, and the surface 265′ is used also as an atmosphere open surface.

As shown in FIG. 9(b), while the shape of the surface 265′ bulged in the shape of the convexly curved surface by the surface tension is being kept, the solvent in the solution 61 is evaporated and the solution is hardened. Namely, while fluidity of a surface layer of the surface 265b′ is being kept, the solvent is evaporated. Specifically, the steam concentration of the solvent in the dry room 209 is made a little lower than the concentration in the saturation time thereby to suppress an evaporation speed of the solvent. The evaporation speed E (g/h) of the solvent is preferably E≦0.0014M, and more preferably E≦0.0007M, in which M (g) is a total weight of the solvent before the evaporation. In case that the steam concentration of the solvent in the dry room 209 is greatly lower than the concentration in the saturation time, the surface layer of the surface 265′ dries rapidly, and its rapid dry cannot follow volume reduction with the evaporation of the solvent, and reduction of the surface area due to the volume reduction, so that there is fear that the convexly curved configuration cannot be kept in such a way that the center portion of surface 265b′ is depressed.

By thus evaporating the solvent, there is obtained a light-transmissible optical member preform 265 having on one surface a second approximate optical surface 265b that is a convexly curved surface. Also, onto the other surface of the light-transmissible optical member preform 265, the configuration of the first approximate optical surface configuration 219a of the mold 211 is transferred, whereby a first approximate optical surface 265a that is a convexly curved surface is formed. A radius of curvature R₁ of the first approximate optical surface 265a is specified by a radius of curvature of the first approximate optical surface configuration 219a of the mold 211. Further, a radius of curvature R₂ of the second approximate optical surface 265b can approximate geometrically to the radius of curvature R₁ by the following numerical expression (i) using a radius r of the light-transmissible optical member preform 265, a volume V₁ of the solution 61, a volume V₂ of the first approximate optical surface configuration 219a of the mold 211, a weight concentration Cw of the nano composite resin included in the solution 61, a density ρ₁ of the solution 61, and a density ρ₂ of the nano composite resin.

$$\frac{Cw \cdot {ρ}_{1}}{{ρ}_{2}} {V}_{1} - {V}_{2} = \frac{π}{3} \{ 2 {R}_{2}^{3} - \sqrt{{R}_{2}^{2} - {r}^{2}} ( 2 {R}_{2}^{2} + {r}^{2} ) \} \qquad ( 1 )$$

In the above numerical expression (i), regarding the nano composite resin having the density ρ₂, in case that the radius r of the light-transmissible optical member preform 265 and the volume V₂ of the first approximate optical surface configuration 219a are set to desired values, the radius of curvature R₂ of the second approximate optical surface 265b is specified by the values of the volume V₁ of the solution 61, the weight concentration Cw of the nano composite resin, and the density ρ₂. These values can be adjusted by selection of the solvent in the solution 61.

Though the weight concentration Cw of the nano composite resin is not particularly specified as long as this method can be executed, it is preferably from 5 wt % to 90 wt %, more preferably from 15 wt % to 70 wt %, and most preferably from 20 wt % to 60 wt %. In case that the weight concentration of the nano composite resin is smaller than 5 wt %, it is difficult to form biconvex curved configuration as long as this method has been executed using this weight concentration. In case that the weight concentration of the nano composite resin is equal to or smaller than 15 wt %, the kind of the solvent is limited in order to form the biconvex curved configuration and there can be the unusable solvent. In consideration of plural choices of the solvents, and a range in which the curvature is easily controlled, the concentration of the solid body is preferably 20 wt % or more. Further, from the viewpoint of handling of the solution, in case that the weight concentration is 90 wt % or more, handling is difficult; and in case that the weight concentration is 70 wt % or more, handling is possible but bubbles remain easily inside the nano composite resin. As a range in which handling is possible and the bubbles do not remain inside the nano composite resin, the weight concentration Cw of the nano composite resin is desirably 60 wt % or less.

The thus formed light-transmissible optical member preform 265 is taken out from the mold 211. Here, when the light-transmissible optical member preform 265 is taken out from the mold 211, in case that releasability is poor, the light-transmissible optical member preform 265 may break. Therefore, by using water repulsive material in the mold 22, an advantage that the releasability can be improved can be obtained. For example, fluororesin such as PTFE can be used by processing. Alternatively, after processing of the metallic material, the pre-finish product may be coated with Ni—P, Ni—P containing fluorine, DLC, DLC containing fluorine, fluorine compound such as triazinethiol, OPTOOL coat by Daikin Industries, Ltd., and Novec coat by 3M Company to form a release film. However, the used materials are limited to these materials.

Influences on the releasability of the light-transmissible optical member preform 265 exerted by the material of the mold 211 and the surface treatment have been confirmed by the following test. The test has been performed as follows: a solution including nano composite resin is applied between two flat plate-shaped substrates, and dried while a fixed load is being applied; and after the dry, the two substrates are torn off by a predetermined load. In this time, by whether the nano composite resin remains on the substrate, the releasability has been judged. A table 1 shows this result. In the table 1, “X” indicates that the nano composite resin remains entirely, “Δ” indicates a case where the nano composite resin remain and a case where the nano composite resin does not remain, and “O” indicates none of the nano composite resin remains. Further, as the solvent of the solution 61, water is used.

TABLE 1

| | | | Contact angle |
|---|---|---|---|
| Sample | Substrate | Releasability | with water (°) |
| 1 | SUS304 board | Δ | 80 |
| 2 | STAVAX board | Δ | 80 |
| 3 | Glass board | X | 35 |
| 4 | Hydrophobic glass board | Δ | 90 |
| 5 | Ni—P plating board | Δ | 65 |
| 6 | Fluorine containing Ni—P | Δ | 110 |
| | plating board | | |
| 7 | DLC coating board | Δ | 85 |
| 8 | Fluorine containing DLC | ◯ | 90 |
| | coating board | | |
| 9 | PTFE board | ◯ | 125 |
| 10 | Novec (3M) coating board | ◯ | 120 |
| 11 | OPTOOL (DAIKIN) Coating | ◯ | 120 |
| | board | | |
| 12 | Triazinethiol coating board | ◯ | 110 |
| 13 | Tefmetal (Nomura Plating Co., | ◯ | 150 |
| | Ltd) board | | |

From the table 1, it is founded that the contact angle between the mold 211 and the water is preferably 35°<θ<180°, more preferably 60°≦θ<180°, and still more preferably 120°≦θ<180°.

As described above, in the preform manufacturing apparatus 400 in the embodiment, on the upper and lower sides of the light-transmissible optical member preform 265, the approximate optical surfaces 265a, 265b that are the convexly curved surfaces are formed. The light-transmissible optical member preform 265 having such the shape is suitable as a pre-finish product of the optical member in which its both sides are convexly curved surfaces.

### (Nano Composite Material)

Next, the nano composite material (in which inorganic fine particles are connected with a thermoplastic resin) used as a material of the optical member of the invention will be described below in detail.

Though the explanation of constituent features described below is made on the basis of the typical embodiment of the invention, the invention is not limited to such the embodiment.

### (Inorganic Fine Particle)

In organic and inorganic composite material used in the invention, the number average particle size of an inorganic fine particle is set to from 1 to 15 nm. In case that the number average particle size of the inorganic fine particle is too small, the feature inherent in the substance constituting the particle can change. To the contrary, in case that the number average particle size of the inorganic fine particle is too large, the influence of Rayleigh scattering becomes remarkable, so that transparency of the organic and inorganic composite material can decrease greatly. Accordingly, it is necessary to set the number average particle size of the inorganic fine particle in the invention to from 1 to 15 nm, preferably to from 2 to 13 nm, and more preferably to from 3 to 10 nm.

As the inorganic fine particle used in the invention, there are, for example, an oxide fine particle, a sulfide fine particle, a selenide fine particle, a telluride fine particle, and the like. More specifically, there are a titania fine particle, an oxide zinc fine particle, a zirconia fine particle, a tin oxide fine particle, a zinc sulfide fine particle, and the like. Preferably, there are the titania fine particle, the zirconia fine particle, and the zinc sulfide fine particle, and there are more preferably the titania fine particle and the zirconia fine particle. However, the inorganic fine particle is not limited to these particles. In the invention, one kind of inorganic fine particle may be used, or plural kinds of particles may be used together.

A refractive index in a wavelength 589 nm of the inorganic fine particle used in the invention is preferably from 1.90 to 3.00, more preferably from 1.90 to 2.70, and still more preferably from 2.00 to 2.70. In case that the inorganic fine particle of which the refractive index is 1.90 or more is used, the organic and inorganic composite material of which the refractive index is larger than 1.65 is easily prepared. Therefore, when the inorganic fine particle of which the refractive index is 3.00 or less is used, there is a tendency that the organic and inorganic composite material of which transmissivity is 80% or higher is easily prepared. The refractive index in the invention is a value measured by an Abbe refractometer (DR-M4 by ATAGO CO., LTD.) in relation to the light having a wavelength 589 nm at a temperature of 25° C.

### (Thermoplastic Resin)

The thermoplastic resin for use in the present invention is not particularly limited in its structure, and examples thereof include a resin having a known structure, such as poly(meth)acrylic acid ester, polystyrene, polyamide, polyvinyl ether, polyvinyl ester, polyvinyl carbazole, polyolefin, polyester, polycarbonate, polyurethane, polythiourethane, polyimide, polyether, polythioether, polyether ketone, polysulfone and polyethersulfone. Above all, in the present invention, a thermoplastic resin having, at the polymer chain terminal or in the side chain, a functional group capable of forming an arbitrary chemical bond with an inorganic fine particle is preferred. Preferred examples of such a thermoplastic resin include:

(1) a thermoplastic resin having a functional group selected from the followings at the polymer chain terminal or in the side chain:

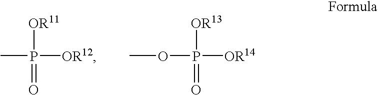

(wherein R¹¹, R¹², R¹³ and R¹⁴ each independently represents a hydrogen atom, a substituted or unsubstituted alkyl group, a substituted or unsubstituted alkenyl group, a substituted or unsubstituted alkynyl group, or a substituted or unsubstituted aryl group), —SO₃H, —OSO₃H, —CO₂H and —Si(OR¹⁵)ₘ₁R¹⁶₃₋ₘ₁ (wherein R¹⁵ and R¹⁶ each independently represents a hydrogen atom, a substituted or unsubstituted alkyl group, a substituted or unsubstituted alkenyl group, a substituted or unsubstituted alkynyl group, or a substituted or unsubstituted aryl group, and m1 represents an integer of 1 to 3); and

(2) a block copolymer composed of a hydrophobic segment and a hydrophilic segment.

The thermoplastic resin (1) is described in detail below.

### Thermoplastic Resin (1):

The thermoplastic resin (1) for use in the present invention has, at the polymer chain terminal or in the side chain, a functional group capable of forming a chemical bond with an inorganic fine particle. The “chemical bond” as used herein includes, for example, a covalent bond, an ionic bond, a coordination bond and a hydrogen bond, and in the case where a plurality of functional groups are present, each functional group may form a different chemical bond with an inorganic fine particle. Whether or not a chemical bond can be formed is judged by when a thermoplastic resin and an inorganic fine particle are mixed in an organic solvent, whether or not the functional group of the thermoplastic resin can form a chemical bond with the inorganic fine particle. The functional groups of the thermoplastic resin all may form a chemical bond with an inorganic fine particle, or a part thereof may form a chemical bond with an inorganic fine particle.

The thermoplastic resin for use in the present invention is preferably a copolymer having a repeating unit represented by the following formula (1). Such a copolymer can be obtained by copolymerizing a vinyl monomer represented by the following formula (2).

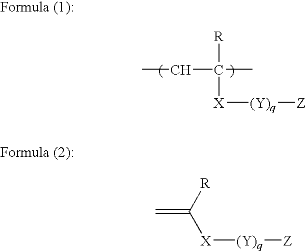

In formulae (1) and (2), R represents a hydrogen atom, a halogen atom or a methyl group, and X represents a divalent linking group selected from the group consisting of —CO₂—, —OCO—, —CONH—, —OCONH—, —OCOO—, —O—, —S—, —NH— and a substituted or unsubstituted arylene group and is preferably —CO₂— or a p-phenylene group.

Y represents a divalent linking group having a carbon number of 1 to 30, and the carbon number is preferably from 1 to 20, more preferably from 2 to 10, still more preferably from 2 to 5. Specific examples thereof include an alkylene group, an alkyleneoxy group, an alkyleneoxycarbonyl group, an arylene group, an aryleneoxy group, an aryleneoxycarbonyl group, and a group comprising a combination thereof. Among these, an alkylene group is preferred.

q represents an integer of 0 to 18 and is preferably an integer of 0 to 10, more preferably an integer of 0 to 5, still more preferably an integer of 0 to 1.

Z is a functional group shown in the Formula above.

Specific examples of the monomer represented by formula (2) are set forth below, but the monomer which can be used in the present invention is not limited thereto.

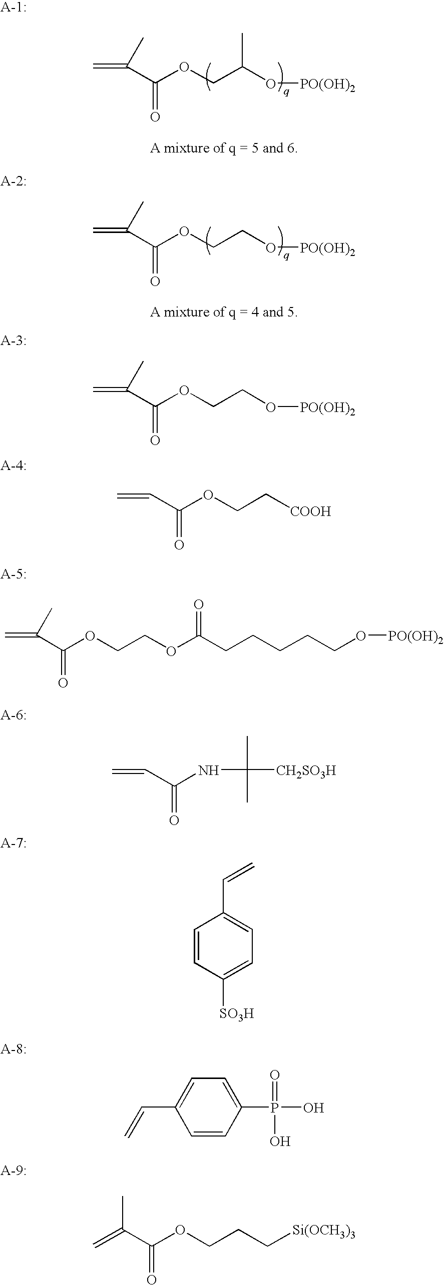

In the present invention, as for other kinds of monomers copolymerizable with the monomer represented by formula (2), those described in J. Brandrup, Polymer Handbook, 2nd ed., Chapter 2, pp. 1-483, Wiley Interscience (1975) may be used.

Specific examples thereof include a compound having one addition-polymerizable unsaturated bond, selected from styrene derivatives, 1-vinylnaphthalene, 2-vinylnaphthalene, vinylcarbazole, acrylic acid, methacrylic acid, acrylic acid esters, methacrylic acid esters, acrylamides, methacrylamides, allyl compounds, vinyl ethers, vinyl esters, dialkyl itaconates, and dialkyl esters or monoalkyl esters of the fumaric acid above.

The weight average molecular weight of the thermoplastic resin (1) for use in the present invention is preferably from 1,000 to 500,000, more preferably from 3,000 to 300,000, still more preferably from 10,000 to 100,000. When the weight average molecular weight of the thermoplastic resin (1) is 500,000 or less, the forming processability tends to be enhanced, and when it is 1,000 or more, the dynamic strength tends to be enhanced.

In the thermoplastic resin (1) for use in the present invention, the number of functional groups bonded to an inorganic fine particle is preferably, on average, from 0.1 to 20, more preferably from 0.5 to 10, still more preferably from 1 to 5, per one polymer chain. When the number of the functional groups is 20 or less on average per one polymer chain, the thermoplastic resin (1) tends to be prevented from coordination to a plurality of inorganic fine particles to cause viscosity elevation or gelling in the solution state, and when the average number of functional groups is 0.1 or more per one polymer chain, this tends to yield stable dispersion of inorganic fine particles.

In the thermoplastic resin used in the invention, the glass transition temperature is preferably from 80 to 400° C., and more preferably from 130 to 380° C. In case that the resin having the glass transition temperature of 80° C. or more is used, an optical member having the sufficient heat-resistance is readily obtained. Further, in case that the resin having the glass transition temperature of 400° C. or less is used, there is a tendency for molding to be readily performed.

### (Solvent)

The solvent used in embodiments of the invention has a property of dissolving the nano composite resin. It is not necessary to limit one kind solvent and a plurality of kinds of solvent may be used. As kinds of the usable solvent, there are, for example, acetic acid, acetone, chloroform, dimethylacetoamide, dimethyl ether, N,N-dimethylformamide, dioxolane, methanol, ethanol, ethyl acetate, tetramethyhydrofuran, toluene, water, and the like, which are not limited.

As described above, in the nano composite material that is the material of the optical member according to the invention, by providing the unit structure of the specific structure also in the resin, without impairing high refractivity and high transparency of the organic and inorganic composite material in which inorganic fine particles are dispersed, mold releasability from the mold can be improved.

According to the above materials, there can be provided the organic and inorganic composite material having the excellent mold-releasability, the high refractivity and the high transparency; and the optical member which is constituted by including its organic and inorganic composite material, and has the high accuracy, the high refractivity and the high transparency.

An example will be described below. In this example, a preform was manufactured by using a preform manufacturing apparatus in FIG. 8. As the solution 61, toluene was used, in which the nano composite resin was dispersed at 50 wt %. As the material of the mold 211, PTFE was used, a radius of curvature of the first approximate optical surface configuration 219a was 8 mm, and a radius r of the preform 265 was 4 mm. Using a precision dispenser “Nano master” by Musashi Engineering Inc., the above solution 61 of 161.62 μL was measured and dropped in the first approximate optical surface configuration 219a. The mean amount of solvent exhaust from the dry room 209 was set to 0.055 mg/h, and the solvent was removed from the solution dropped in the first approximate optical configuration 219a for sixty days. Namely, the evaporation speed E (g/h) of the solvent is E≦0.0007M, in which M (g) was total weight of the solvent before evaporation. A radius of curvature R₁ of the first approximate optical surface 265a of the preform 265 manufactured in this condition was 8 mm, and a radius of curvature R₂ of the second approximate optical surface 265b was 7.7 mm. The preform 265 was taken out from the mold 211, and heat-press molded in a heating compressor by means of a biconcave lens mold having a flange diameter of 8 mm, a lens surface effective diameter of 4 mm, and a lens radius of curvature of SR 9 mm under such a condition that a heating temperature is 180° C., pressing force is 70 kgf, and a heating time was 2 min. In result, an optically good lens having no bubbles and weld line was molded.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2007-95373 filed Mar. 30, 2007, the contents of which are incorporated herein by reference.

1. A method for manufacturing a preform from a nano composite resin that includes a thermoplastic resin containing inorganic fine particles, the preform being a pre-finish product of an optical member having an optical surface formed by press molding,
the method comprising;
supplying a solution including the nano composite resin and a solvent into a mold which has an approximate optical surface closely resembling the optical surface and an opening to an atmosphere; and
evaporating the solvent while a shape of the approximate optical surface is kept, to solidify the solution.

2. The method according to claim 1, wherein the solution is supplied so as to include the nano composite resin in such an amount that the preform can be formed.

3. The method according to claim 1, wherein
the optical member has a first optical surface and a second optical surface on upper and lower sides thereof;
the mold includes a lower mold and an upper mold inserted into the lower mold;
the low mold has a first approximate optical surface configuration on a bottom surface thereof, the first approximate optical surface configuration being for forming a first approximate optical surface closely resembling the first optical surface;
the upper mold has a second approximate optical surface configuration on an surface of the upper mold which is opposed to the bottom surface of the lower mold, the second approximate optical surface configuration being for forming a second approximate optical surface closely resembling the second optical surface;
the solution is supplied into the lower mold; and
the upper mold is inserted into the lower mold before the solution is solidified.

4. The method according to claim 3, wherein
each of the first optical surface and the second optical surface is a convex surface; and
each of the first approximate optical surface configuration and the second approximate optical surface configuration is a concave surface.

5. The method according to claim 1, wherein
the optical member has a first optical surface and a second optical surface on upper and lower sides thereof, each of the first optical surface and the second optical surface being a convex surface;
the mold has a convex surface configuration on a surface of the mold, the convex surface configuration being for forming a first approximate optical surface closely resembling the first optical surface; and
the solution is bulged by a surface tension acting between the solution overflowing from the convex surface configuration and the surface of the mold, so as to form a second approximate optical surface closely resembling the second optical surface.

6. The method according to claim 5, wherein the solvent is evaporated while a fluidity of a surface layer of the second approximate optical surface is kept.

7. The method according to claim 6, wherein when a total weight of the solvent before evaporating is taken as M by g and an evaporation speed of the solvent is taken as E by g/h, M and E satisfy E≦0.0014M.

8. The method according to claim 1, wherein
the solvent is evaporated from the opening until the solution becomes a gel body; and
the gel body is taken out from the mold, and the solvent is further evaporated until a residual solvent amount comes to 5000 ppm or less.

9. The method according to claim 1 or 8, wherein a contact angle θ between the mold and water is 35°<θ<180°.

10. An apparatus for manufacturing a preform from a nano composite resin that includes a thermoplastic resin containing inorganic fine particles, the preform being used as a pre-finish product of an optical member having a first optical surface and a second optical surface on upper and lower sides thereof which are formed by press-molding,
the apparatus comprising a mold which has a first approximate optical surface closely resembling the first optical surface, a second approximate optical surface closely resembling the second optical surface, and an opining to an atmosphere open, and into which a solution including the nano composite resin is supplied,
wherein
the mold includes a lower mold and an upper mold inserted into the lower mold;
the lower mold has a first approximate optical surface configuration on a bottom surface thereof, the first approximate optical surface configuration being for forming the first approximate optical surface; and
the upper mold has a second approximate optical surface configuration on an surface of the upper mold which is opposed to the bottom surface of the lower mold, the second approximate optical surface configuration being for forming a second approximate optical surface closely resembling the second optical surface.

11. The apparatus according to claim 10, wherein
each of the first optical surface and the second optical surface is a convex surface; and
each of the first approximate optical surface configuration and the second approximate optical surface configuration is a concave surface.

12. An apparatus for manufacturing a preform from a nano composite resin that includes a thermoplastic resin containing inorganic fine particles, the preform being used as a pre-finish product of an optical member having a first optical surface and second optical surface on upper and lower sides thereof, each of the first optical surface and the second optical surface being a convex surface,
the apparatus comprising a mold, which has a first approximate optical surface closely resembling the first optical surface, a second approximate optical surface closely resembling the second optical surface, and an opening to an atmosphere, and into which solution including the nano composite resin is supplied,
wherein the mold has a convex surface configuration on a surface thereof, the convex surface configuration being for forming the first approximate optical surface, and the mold acts a surface tension between the solution overflowing from the convex surface configuration and the mold in such a manner that the solution is bulged to form the second approximate optical surface.

13. A preform manufactured by a method according to claim 1.

14. An optical member formed by press-molding a preform according to claim 13.

15. The optical member according to claim 14, which is a lens.
